(19) United States
(12) Patent Application Publication
(10) Pub. No.: US 2015/0032485 A1
(43) Pub. Date: Jan. 29, 2015

(54) Digital method For Providing Transportation Services

(71) Applicant: Mark Nelson, Boca Raton, FL (US)

(72) Inventor: Mark Nelson, Boca Raton, FL (US)

(21) Appl. No.: 13/951,384

(22) Filed: Jul. 25, 2013

(51) Int. Cl. G06Q 10/02; G06Q 50/30

(52) U.S. Cl. CPC G06Q 10/02; G06Q 50/30
USPC 705/5

(57) ABSTRACT

A method for providing airline patrons with a car service reservation system which allows for the facilitation of car service usage and an efficient pricing system for customers to work with each car service on a flat fee, non-metered basis. The transportation service provider system described in this patent allows patrons to rate the transportation service they receive upon arrival to their respective final destination.

### REFERENCE TO RELATED APPLICATIONS

This application is a continuation-in-part of U.S. patent application Ser. No. 13/278,253 filed on Oct. 21, 2011 having a common inventor and entitled A DIGITAL METHOD FOR PROVIDING TRANSPORTATION SERVICES RELATED APPLICATIONS.

### BACKGROUND OF THE INVENTION

1. Field of the Invention

This invention is directed to providing transportation services for potential customers while booking other travel reservations, i.e., airline, train, cruise ship, etc., and more particularly to a method for assisting customers with an instant digital transportation reservation system.

2. Background of the Invention

A system for providing a transportation reservation service is known in the prior art. More specifically, by way of example, U.S. PreGrant Publication No. 2006/0059023 A1 to Mashinsky discloses a system and method for providing taxi patrons with a taxi-reservation system (metered transportation services) which facilitates better taxi service, better time utilization and financial rewards for taxi drivers who provide better service, and more efficient pricing for buyers. The taxi-reservation system allows patrons to rate the taxi service they receive as well as pre-select taxi drivers from a pool of available taxi drivers. The system further enables taxi drivers to participate in a pricing scheme where customers can bid on proposed fares for their trips, and drivers, dispatchers or companies can bid on customers.

The contents of various portions of the system for providing taxi patrons with a taxi-reservation system which facilitates taxi service, time utilization and financial rewards for taxi drivers who provide better service, and more efficient pricing for buyers which is disclosed in prior art US PreGrant Publication No. 2006/0059023 A1, are incorporated herein in whole or in part to provide a more complete and better understanding of this invention.

The purpose of this invention is to allow airline, train, cruise ship, etc., reservation customers the ability to reserve transportation services on the same website. This method is to provide customers the ability to reserve ground transportation services (non-metered transportation services) via the internet utilizing various airline and intermediate websites. By incorporating this invention each company will alter their GUI (graphical user interface) so it will support this invention. As it is difficult for private transportation service providers “transportation service provider” to pick-up potential customers without going through a protracted reservation process, transportation service provider works through a digital form of communication, i.e., e-mail and SMS (aka text messaging) that receives requests from customers for scheduled transportation. These services then communicate with local transportation service providers of the customer's departure and arrival points. Transportation service providers are contacted via e-mail while the customer is booking a flight and/or hotel reservations utilizing GUI which is provided to the aforementioned airline and intermediately travel associates. Customer bookings can not reserve transportation no later than 24 hours before required service. No metered transportation service providers are allowed or permitted to subscribe to this service and there will be no bidding for potential clients.

Mashinsky's invention focuses on taxis which are metered vehicles governed by the state as to set prices; whereas, the present invention is focused on non-metered transportation services. Mashinsky's invention enables taxi drivers, dispatchers or companies to bid on customers, therefore, the customer needs to wait for a while to get the best price. Whereas the present invention allows customers to get the best price and service without going through a protracted bidding process. The present invention provides an “instant” price quote to the customer.

### SUMMARY OF THE INVENTION

The purpose of this invention is to provide transportation service provider patrons with a digital vehicle service reservation system which allows better ground transportation service, better time utilization for transportation service provider's who provide better service and more efficient pricing for customers.

The service disclosed solves various problems associated with the identification, reservation, procurement, dispatch, pricing, rating and payment for car services by customers.

This invention involves a new method of digital communication operated by a user, involving the following sequence: accessing a transportation reservation system via an internet-enabled device for airline, train, cruise ship via America Airlines, Delta, United, etc. websites; the transportation reservation system being in communication with a plurality of independent travel service providers via e-mail; instant pricing can be transmitted to the potential customer from the database; receiving transportation service information from the transportation reservation system by e-mailing transportation service providers in the areas that the customer will be traveling in response to the travel service request; this may involve e-mailing multiple transportation service providers in multiple cities; transmitting pricing and a travel service request confirmation to the customer; and receiving transportation service in accordance with the confirmation e-mail; at completion of travel, the system will e-mail the customer a survey for rating the level of service received by the transportation service provider(s).

The invention involves a method of providing transportation services by a digital reservation service provider, including: receiving e-mail notification from a plurality of independent transportation service provider(s) regarding availability for providing transportation; receiving a reservation request from a customer; transmitting the reservation request to a transportation service provider; receiving confirmation from the transportation service provider regarding providing transportation service(s).

In an exemplary embodiment of the present invention, there is disclosed a computer implemented method for digitally receiving assistance with transportation reservations, comprises:

a. accessing a transportation reservation system via an Internet-enabled device, said transportation reservation system being in digital e-mail communication with a plurality of independent travel service providers;

b. digitally transmitting a travel service request to the transportation reservation system;

c. receiving transportation service information digitally from the transportation reservation system in response to the travel service request;

d. transmitting a digital travel request confirmation to the transportation reservation system; and

e. receiving transportation service in accordance with a digital confirmation.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIGS. 1A and 1B is a copy of a transportation service provider sign up form;

FIG. 2 is a flow diagram of a user direct sign up form;

FIG. 3 is a diagram of a user second party air sign up process where the second party is Virgin Air;

FIG. 4 is a diagram of a user second party cruise ship sign up process where the second party is Royal;

FIG. 5 is a diagram of a user second party train company sign up process where the second party is AMTrack;

FIG. 6 is a diagram of a user third party sign up process where the third party is EXPEDIA;

FIG. 7 is a flow diagram of a completion of travel survey form; and

FIG. 8 is a flow diagram of a method for a transportation service provider reservation system which provides transportation service provider patrons access to a system where patrons can rate the service they receive. As a result, patrons can enjoy better services;

FIG. 9 is a flowchart depicting an exemplary process of establishing the transportation service providers and service fees database for the transportation service reservation system and method;

FIG. 10 is a diagram of a step ladder approach to group transportation service providers into several baskets based on the service providers' pre-entered bids for a service;

FIG. 11 is a flowchart depicting an exemplary process of providing transportation service reservation by a transportation service reservation system.

FIG. 12 is a copy of additional form for the transportation service provider (TSP) to provide flat rates for specified transportation services and a flat rate per mile for unspecified transportation services.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated devices, and such further applications of the principles of the invention as illustrated therein being contemplated as would normally occur to one skilled in the art to which the invention relates.

The digital transportation service provider reservation system provides transportation service provider patrons access to a system which allows patrons to rate the service they receive. As a result, patrons can enjoy better services. The transportation service provider reservation system comprises an application with two user interfaces: a transportation provider interface and a customer interface which may be located on various websites, i.e., American Airlines, Delta, United with a ever changing GUI (graphical user interface). The transportation service provider is accessible by registered transportation service providers and dispatchers who sign up for our service. The software allows management of car inventory and availability, allowing transportation service provider dispatchers to select arriving and departing passengers in a non-bid format. The system will interface with limo companies so all such functions can be performed automatically based on real time matching to optimize fleet utilization. The customer interface is accessible by any airline user or wholesale reservation network equipped with the interface protocol which is accessible via computer, smart phone, or any wireless internet access device (such as a Palm VII, Blackberry, WAP phone, and the like), which allows potential customers to schedule, view pricing and book available transportation services and to rate driver service. The application server may reside anywhere on the Internet, and comprises commercial Relational Database Management Systems (RDBMS), middleware and presentation software with our custom programming.

This system allows customers to locate the right company based on vehicle location and price. Such ranking can be based on many parameters including price, location, length of time required, pickup and delivery flexibility, car type and other parameters decided by our company.

This system allows via SMS (aka text messaging) notified drivers of changes in flight, train, and ship arrival and departure information where necessary so that rescheduling can be made immediately upon such information becoming available, as opposed to the common practice of having car drivers sit and wait just to be notified of the delays or cancellation.

The transportation service provider reservation system provides origin and destination data which is submitted by the user. This information is then used by the transportation companies for a reservation. The system also automatically provides pricing information based on time of day so supply & demand considerations, historical pricing data and special charges may be included as well as all anticipated tolls and gratuity charges. As a result, this system allows matching of the exact type of vehicle to the exact requirement of the passenger, as well as number of passengers.

As a result, customers and transportation service providers can use a central system to conduct all of their transactions in an automated dispatch. In one embodiment, payment is made at time of reservation so drivers don't have to carry cash or expensive credit card authorization equipment. By digitizing car availability and scheduling from several transportation service providers a much higher availability, utilization and matching of supply and demand is possible. This results in higher revenues for the car companies while providing lower fares to the passengers. Transportation service providers simply select their jobs and then check in electronically to the system each day to confirm their acceptance of the daily trips and go ahead to drive their cars.

Furthermore, the data of the system may be linked to the airline, train, ship, hotel, tourist reservation systems and other reservation networks. As a result, a complete online trip planning identification, scheduling, and payment workflow can be enabled. By the use of digital information, the system confirms that a driver is on their way to pick up a specific passenger, and if the driver is not available or has, for example, a problem with their car, the system immediately reassigns another pending driver with an assignment to perform the job and reconciles the payment data as well as the notification to passenger.

Access to such a digital reservation system can be initiated using other reservation networks, a web browser, wireless devices or telephones, in which case the calls are placed to a central call center. The system may utilize outside networks to provide other relevant information such as flight times, weather or scheduled arrival and departure of transportation system.

The database collects and records information related to the users who access the system, including their e-mail addresses, as well as rating and satisfaction information so that it can be rated for internal purposes only. Such information is added to the actual performance of drivers which include; on time arrival, and other relevant parameters.

By providing transportation companies with free on line software that they can use to manage their reservation and scheduling, the central server has access in real-time to the status of both independent car drivers as well as the inventory and availability of car service companies. The system is designed to accommodate reservations for less than 50 passengers per pick up/drop off.

As a result of this setup, the job of the database is changed to deal with exceptions and the maximization of revenues for its transportation service providers, because all the reservation flow is digital and done automatically by the system.

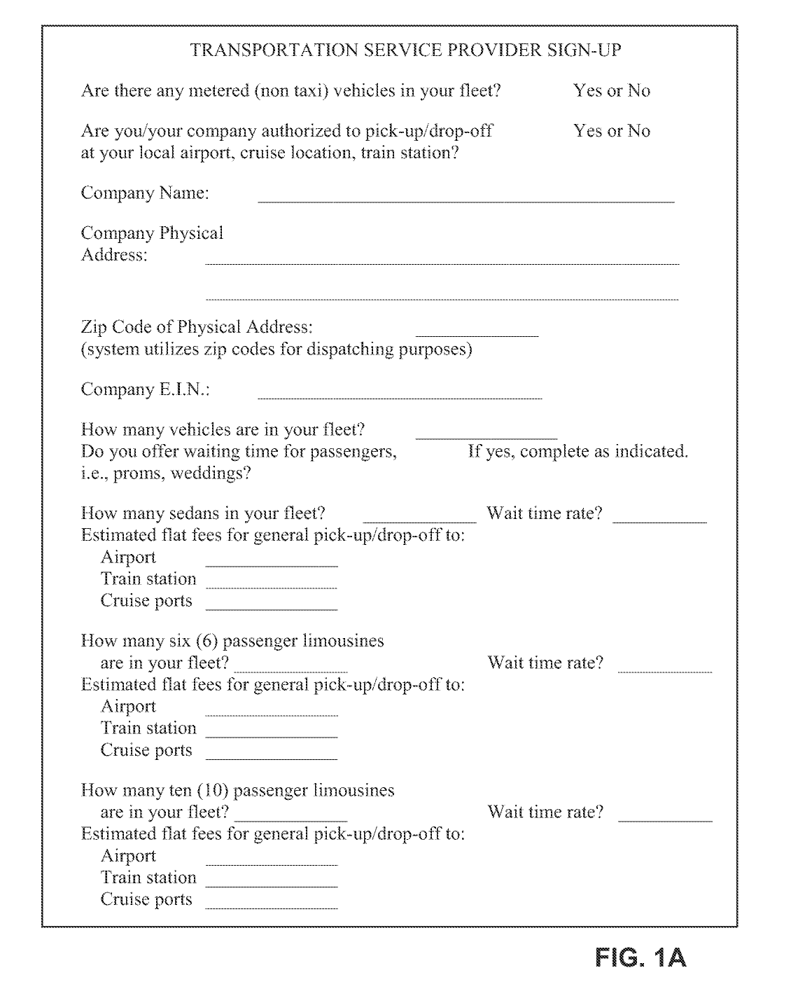

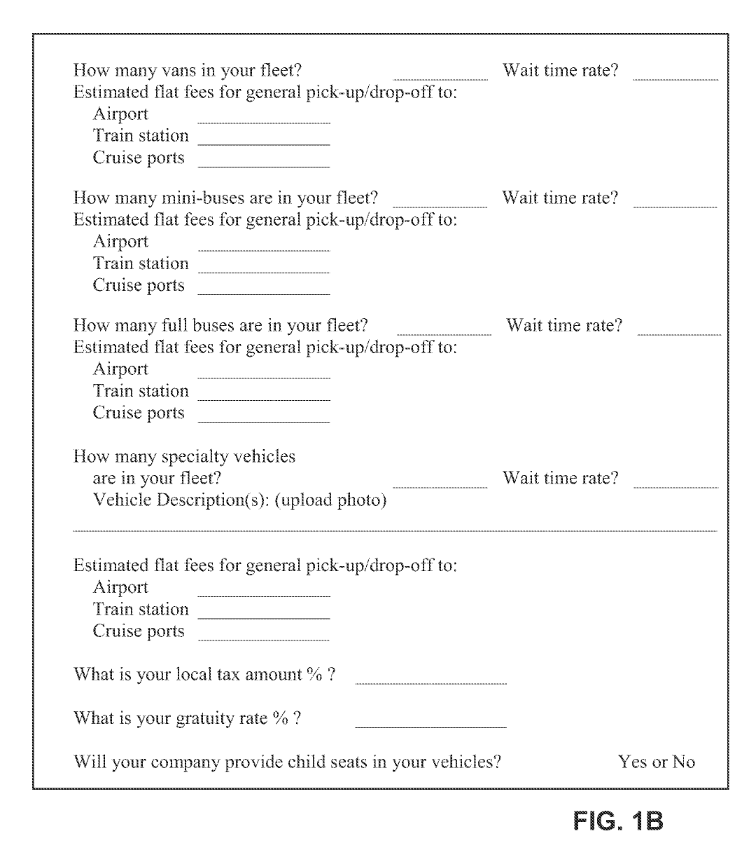

FIGS. 1A and 1B show a copy of a transportation service provider sign up form. The transportation service provider provides estimated flat fees for specified trip service, for example, common pick-up/drop-off for example, airport, train station and cruise ports. Other common or popular pick-up/drop-off places include but are not limited to popular hotels, and popular tourist sightseeing places may also be specified in the sign-up form. In the sign-up form, the transportation service provider will also provide a flat rate (i.e. a price per mile) and other charge for the reservation system to determine the estimated price for the unspecified trip, for example, a trip from airport to a customer's home.

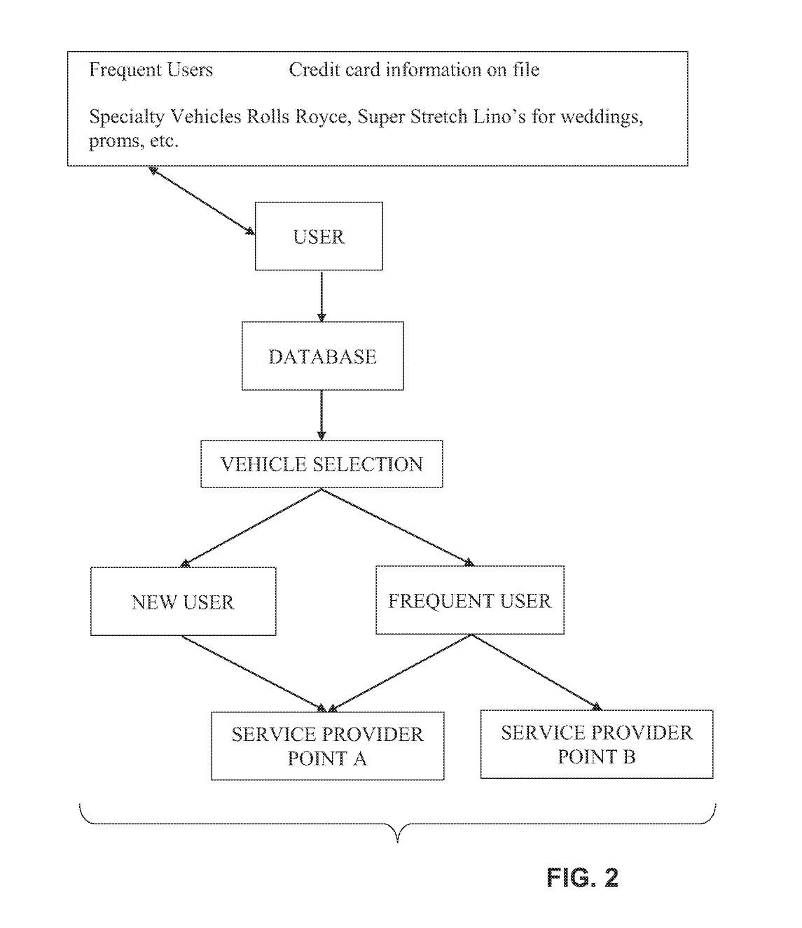

FIG. 2 is a flow diagram of a user direct sign up form;

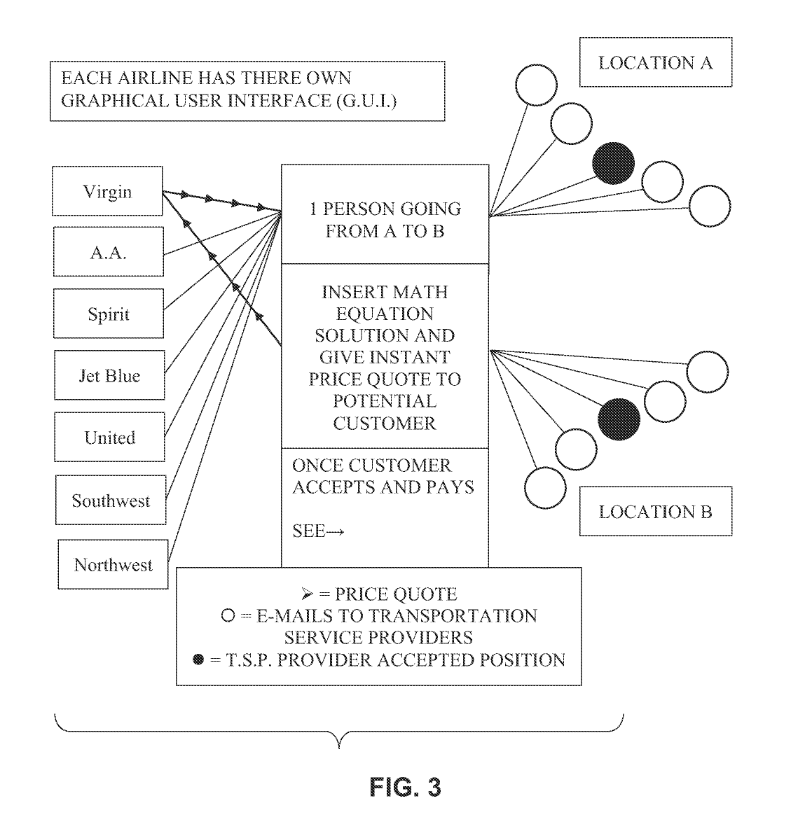

FIG. 3 is a diagram of a user second party air sign up process where the second party is Virgin Air;

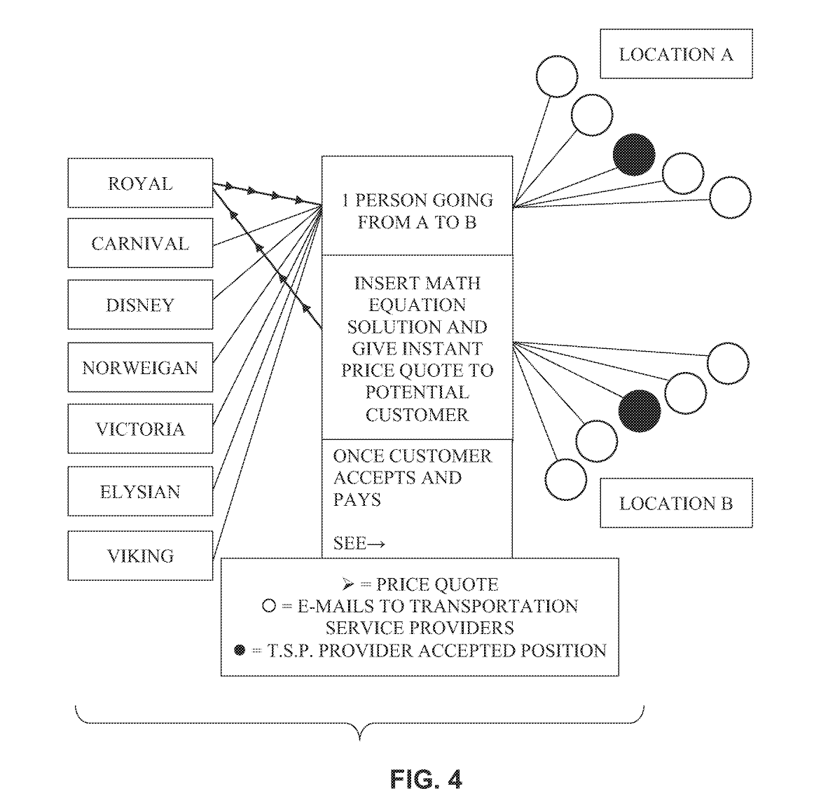

FIG. 4 is a diagram of a user second party cruise ship sign up process where the second party is Royal;

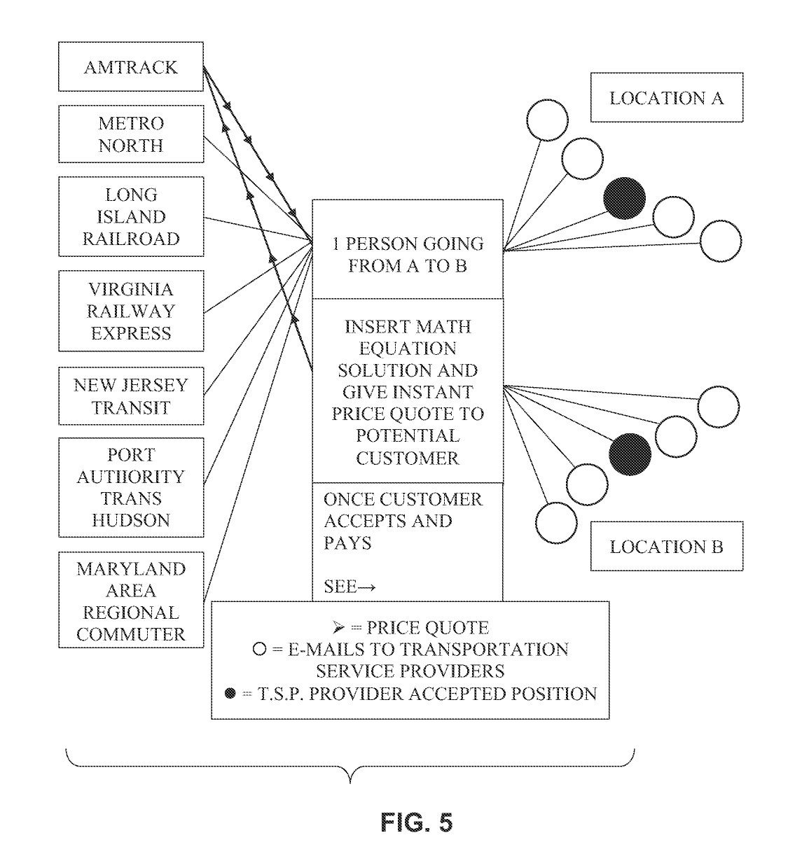

FIG. 5 is a diagram of a user second party train company sign up process where the second party is AMTrack;

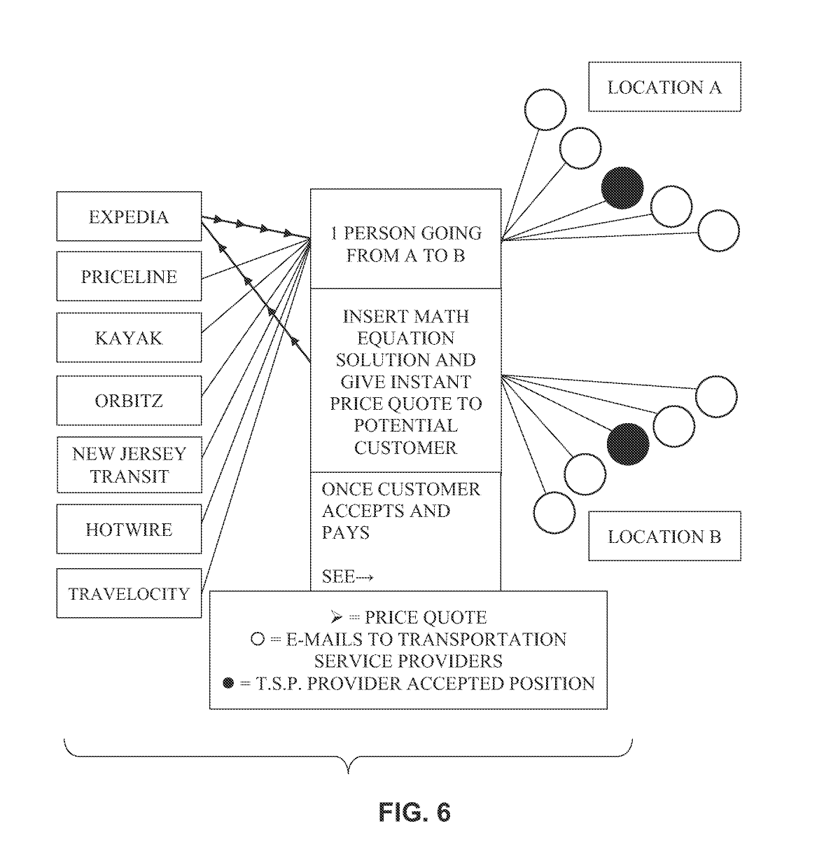

FIG. 6 is a diagram of a user third party sign up process where the third party is EXPEDIA; and

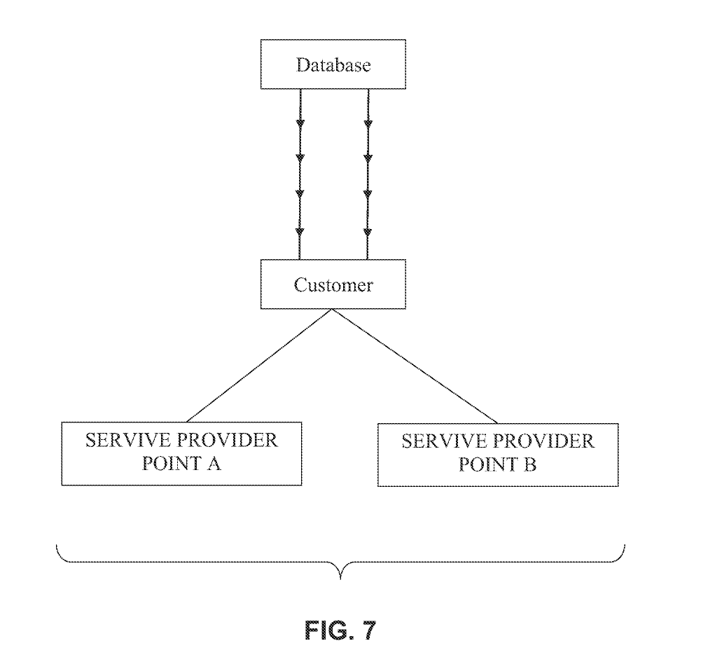

FIG. 7 is a flow diagram of a completion of travel survey form.

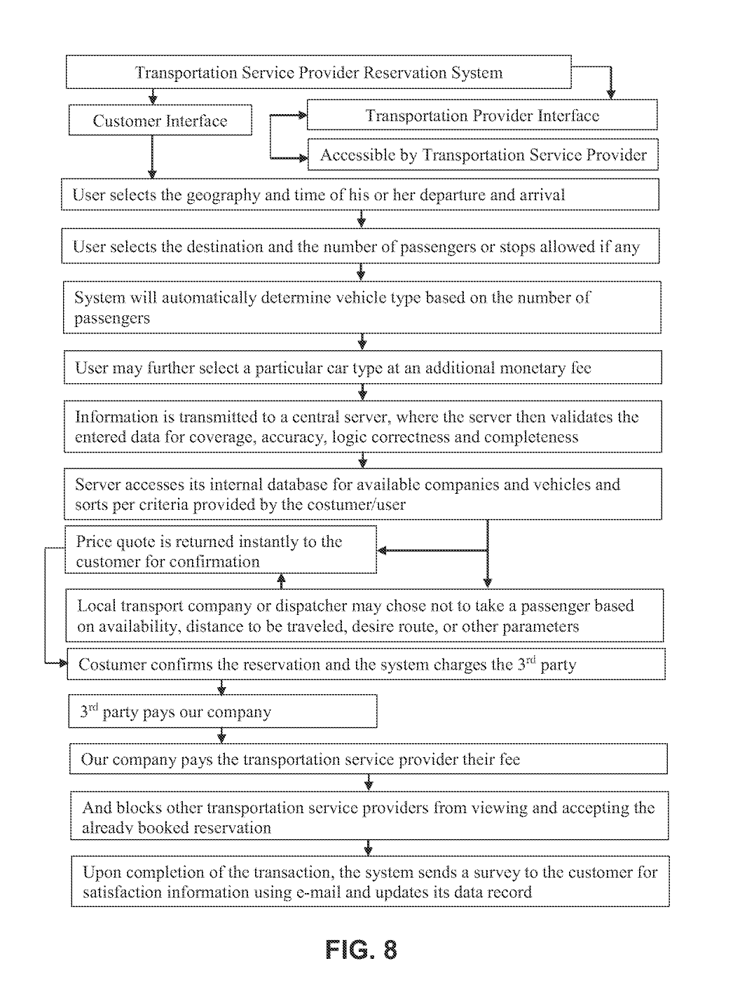

Referring to FIG. 8, there is shown a flow diagram of a method for a transportation service provider reservation system which provides transportation service provider patrons access to a system where each patron can rate the service they receive.

The method shown in FIG. 8 may be performed in real time on a computer having application software installed to cause the computer to operate in accordance with the method. The computer system is comprised on a personal computer, The computer has memory to store the software and a processor to execute the method, The computer also has input means typical of a personal computer, such as a keyboard and a mouse.

Continuing with FIG. 8, the Transportation Service Provider Reservation System 10 consists of an application with two interfaces: a transportation provider interface 12 and a customer interface 14. The transportation service provider interface, block 12, is accessible by registered transportation service providers and dispatchers who sign up for our service. The software allows management of car inventory and availability, allowing transportation service provider dispatchers to select arriving and departing passengers in a non-bid format. The system will interface with limo companies so all such functions can be performed automatically based on real time matching to optimize fleet utilization.

The customer interface 14 is accessible by any airline user or wholesale reservation network equipped with the interface protocol which is accessible via computer, smart phone, or any wireless internet access device (such as a Palm VII, Blackberry, WAP phone, and the like), which allows potential customers to schedule, view pricing and book available transportation services and to rate driver service.

Customers can access the reservation system using a computer or wireless device or third party linked software i.e., ever changing GUI to accommodate/match various transportation websites, i.e., American Airlines, Delta, United, etc for non-metered transportation service providers (no taxi's). Next, the user selects the geography and time of his or her departure and arrival, and indicates his or her time of pickup, block 20. The user selects the destination and the number of passengers or stops allowed if any, block 22. The system will automatically determine vehicle type based on the number of passengers, i.e., 1 to 2 passengers default to a standard sedan, three or more passengers will automatically eliminate standard sedans, block 24. The user may further select a particular car type at an additional monetary fee, any special requirements and/or may request an upgrade, block 26.

This information is transmitted to a central server, where the server then validates the entered data for coverage, accuracy, logic correctness and completeness, block 30. The server accesses its internal database for available companies and vehicles and sorts per criteria provided by the customer/user, block 32. The price quote is returned instantly to the customer for confirmation, block 34. If acceptable by the customer, the customer confirms the reservation and the system charges the 3rd. party, block 36. Then the 3rd party pays our company, block 38, and then our company pays the transportation service provider their fee, block 40. However, the local transport company or dispatcher may choose not to take a passenger based availability, distance to be traveled, desired route, or other parameters, block 42. In such a situation, the system would automatically seek out other transportation service provider companies and contacted in a like manner.

The system then matches such request and notifies all involved parties (transportation service provider driver and the customer) and blocks other transportation service providers from viewing and accepting the already booked reservation, block 44. In one embodiment, the system may also track an airline (where, for example, the user is being picked up from an airport) by accessing the flight database or sending confirmation SMS or e-mail messages to the drivers to reschedule the pick up time.

Upon completion of the transaction, the system sends a survey to the customer for satisfaction information using e-mail and updates its data records, block 46.

The system will have a database for the central controller. The database may comprise a car information database and dispatchers, customer information database, and a database comprising information from other networks, i.e., American Airlines, Delta, Orbitz, Travelocity, etc. The car information database will store information on the location of vehicle, type of vehicle, number of vehicles, availability of vehicle, typical cost of a travel and customer rating. The user/customer information database may store information on the location of a user, desired destinations, desired times of pickup at locations, desired time of drop-off at destination, payment information, and number of riders. All of this information would be updated frequently since most of this information is constantly changing. The system utilizes text messaging through each ground transportation company to notify drivers of any delayed of flights or ship departure/arrival information. Provided that the dispatcher assigns a specific job to a specific driver and inputs his mobile device phone number. By doing so, this will eliminate the ground transportation companies resources i.e., drivers, not to wait for delayed flights thus increasing their profitability.

It is to be understood that the invention is not limited to the locality where the server resides. The car information database may contain data related to hundreds of cities. According to the system parameters, it is to operate and provide transportation services in remote locations and urban settings.

It is further understood that the system will only permit transportation service providers who are authorized and licensed to pickup and/or drop off customers should the location need require such.

The website sorts user data by requesting the necessary parameters, such as cost, timing, car size and type of vehicle sought to accommodate the legally correct number of passengers as well as required local law regarding child seats. The system will display the sorted data to the dispatchers. The system receives the user selection, which is based on the sorted data that was displayed to the user/customer.

The website and dispatcher communicates user data to the driver. The dispatcher/transportation service provider accepts incoming jobs via e-mail and provides services at the requested date, time, pick-up location, to be completed by the customer's request when booking their airline/cruise trip.

At completion when the customer arrives at his/her destination, the system will e-mail the customer to rate the quality of service.

In summary, the system and apparatus provides digital travel reservations. The travel reservation system receives travel information from an airline/cruise customer, and validates travel information received. Next, the system accesses its central database to search for available transportation providers in accordance with the received travel information and transmits information regarding available of transportation and price to the customer via the internet. When e-mails are sent to local transportation service providers, and a transportation service provider accepts the job, all other transportation service providers will be locked out from viewing and accepting the reservation in order eliminate double booking of services. The customer receives confirmation regarding the booking and payment of transportation services, and the system transmits reservation information to local transportation service provider via e-mail in conformance with the confirmation received from the customer.

It is to be understood that the term “transportation service provider” by definition for the system is for non-metered vehicles only and has been used herein and in the following claims in the broadest sense possible.

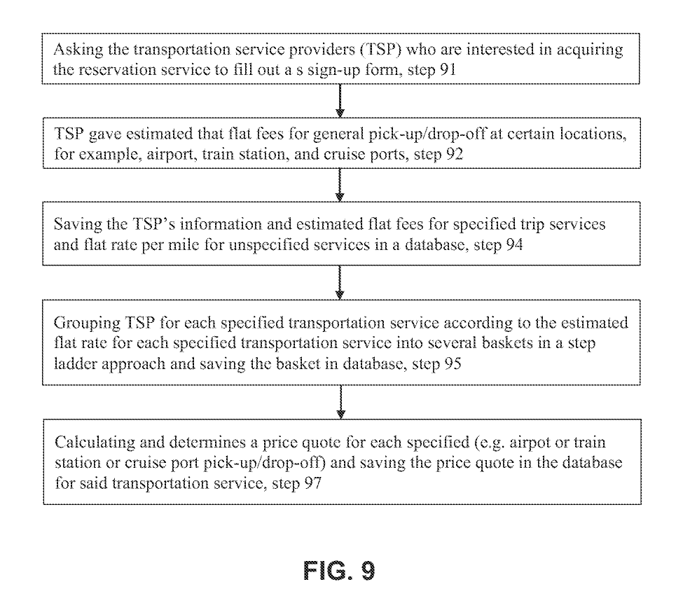

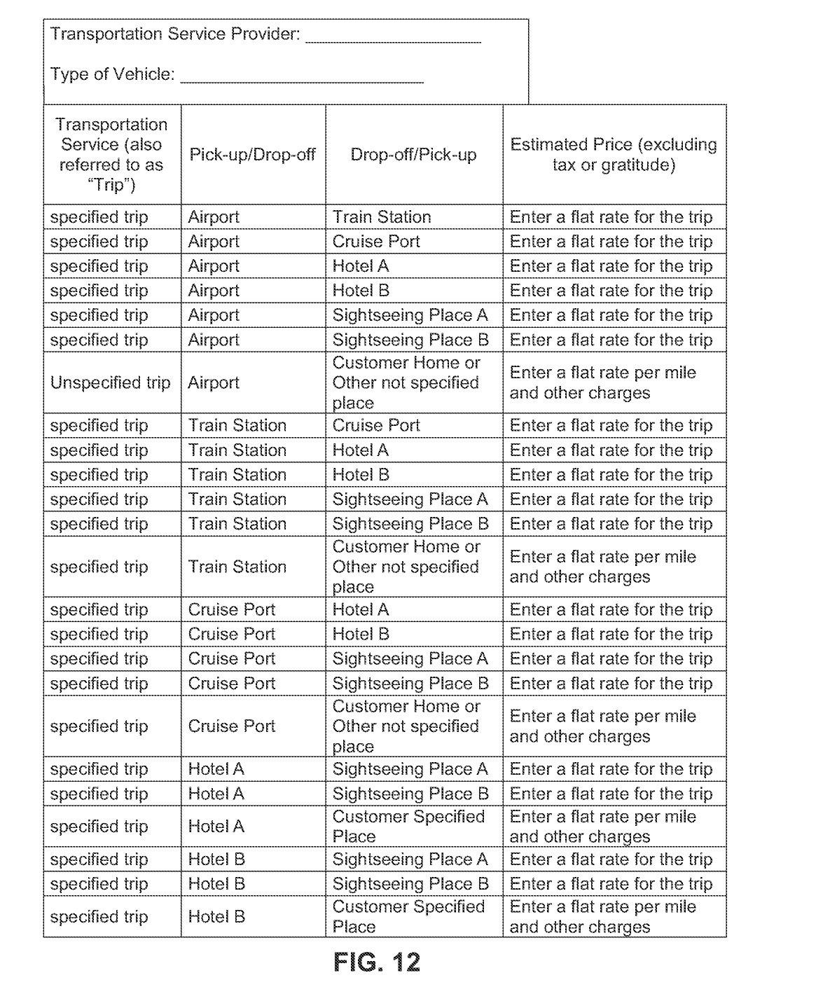

Referring to FIG. 9, there is disclosed an exemplary business method of establishing the transportation service providers (“TSP” hereinafter) and transportation pre-determined fees database for the transportation service reservation system and method. At block 91, the server of the transportation service reservation system asks the TSPs who are interested in utilizing the transportation service reservation system and method to fill out a sign-up form (FIG. 1) wherein the TSP gave estimated flat fees for specified transportation services (also referred as “specified trip”) which are typically general pick-up/drop-off at certain popular/common locations; for example, airport, train station, and cruise ports at step 92. Pick-up/drop-off at other common locations such as popular hotels or tourist sightseeing spots may also be added as specified transportation service to the sign-up form at block 92. This information may also be entered in other forms or type of format. (See FIG. 12) At block 94, the server saves the TSPs' information and estimated flat fees in a database and flat rate per mile for unspecified transportation service (also referred as “unspecified trip”) in a database.

At step 95, for each specified trip, the server divides the TSPs into different baskets according to the estimated flat fees in a step ladder approach. A first basket consists of the TSPs whose estimated flat fees are one of the lowest for said trip; a second basket consists of the TSPs whose estimated flat fees are higher than the first bracket but lower than the third bracket for said trip; a third basket consists of the TSPs whose estimated flat fees are higher than the second bracket but lower than the fourth bracket for said trip; the fourth bracket consists of the TSPs whose estimated flat fees are higher than the third bracket but lower than the fifth bracket; the fifth bracket consists of the TSPs whose estimated flat fees are higher than the fourth bracket.

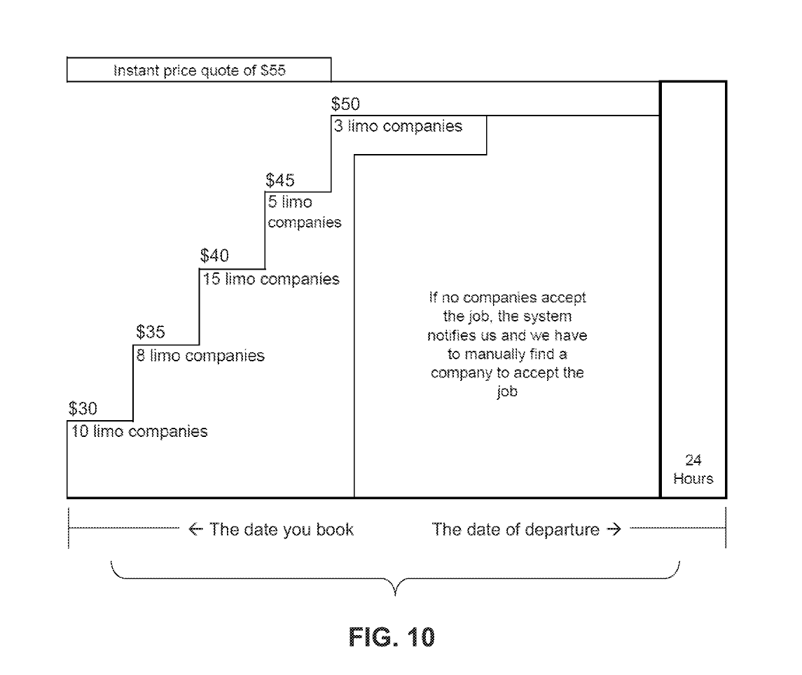

A diagram of a step ladder approach to group the TSPs into several baskets based on the TSP's estimated flat fee for a specified trip is illustrated in FIG. 10.

Then, at step 97, the server of the transportation service reservation system and method calculates and determines a price quote for each specified trip (e.g. airport or train station or cruise port pick-up/drop-off) and saves the price quote in the database for said trip so that when a customer requests for a transportation service, the server can search the database and immediately provide a price quote to the customer so that the customer does not need to wait.

The estimated flat fee for the specified transportation service can be updated by TSPs anytime by logging into the TSP interface of the system. Other specified transportation service can be added to the server anytime by the system administrator.

The server also asks the TSP to offer estimated fee per mile and additional charge for any unspecified trip, for example, a trip picked up from the airport to a customer's home or vice versa. Then the server can calculate a price quote based on the information offered by a customer (e.g. address) and the estimated flat rate per mile offered by the TSP plus additional charge using a pre-determined mathematical equation.

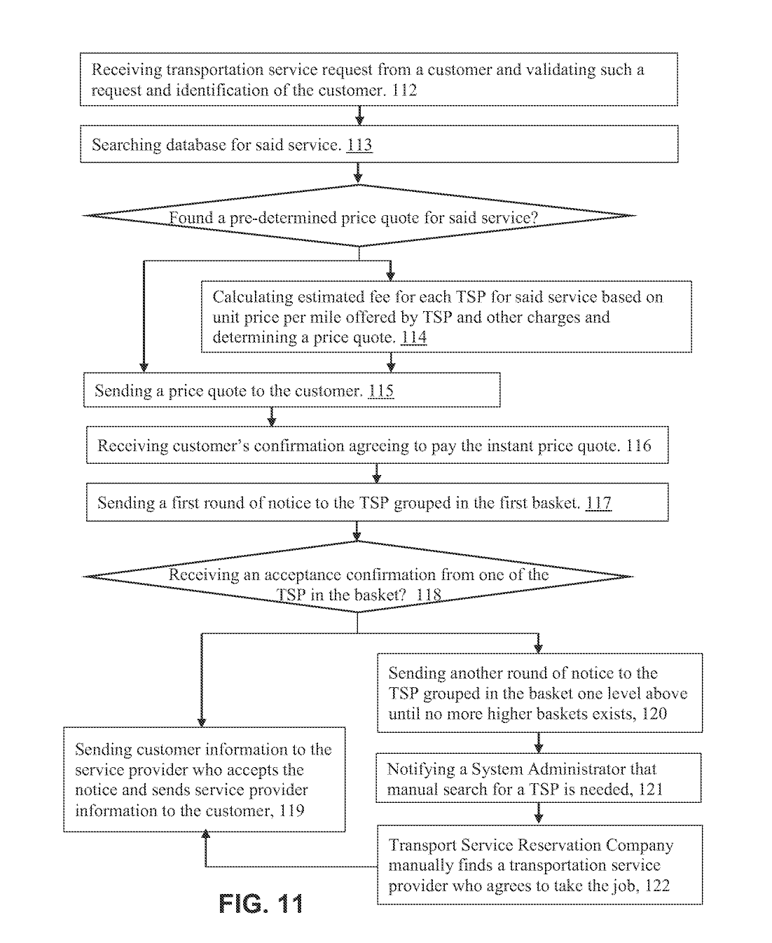

Referring to FIG. 11, there is disclosed an exemplary business method for providing transportation service reservation system. The server of the transportation service reservation system has a customer interface for allowing the customer to place transportation service request. At step 112, the server receives transportation service request from a customer. At step 113 and 115, the server searches a price quote in the database for said service and sends the instant price quote to the customer so that the customer does not need to wait if the transportation request is one of specified trips in the database that already has a price quote. At step 114, if the requested transportation service is not one of the specified trips saved in a database, the server calculates the price using a mathematical equation based on the estimated flat rate per mile offered by the TSPs for all TSP and add additional service charge to come up with a price quote. The calculated price quote is then sent to the customer at step 115. The server has interface allowing the customer's to confirm acceptance. At step 116, the server receives customer's reservation confirmation agreeing to pay the instant price quote. At step 117, the server sorts out the potential TSPs in the first basket of said service in the database and sends a first round of notice to the TSPs grouped in the first basket. At step 118, if the server receives an acceptance confirmation from one of the TSPs in the first basket, then the server sends customer information to the TSP who accepts the transportation reservation and sends the TSP information to the customer at 119.

If no acceptance confirmation received from any TSP in the first basket, another round of notice is sent to the TSP grouped in a basket one level above until no more higher basket is available at step 120.

For example, if there are five baskets for said service in the database, a second notice will be sent to the TSPs grouped in the second basket. If no acceptance confirmation from the TSPs in the second basket, a third notice will be sent to the TSPs in the third basket. If no acceptance confirmation from the TSPs in the third basket, a fourth notice will be sent to the TSPs in the fourth basket. If no acceptance confirmation from the TSPs in the fourth basket, a fifth notice will be sent to the TSPs in the fifth basket. If no acceptance confirmation received from the TSPs in the fifth basket, the server will alert the reservation service system administrator (or company who coordinates the server and operation) at 121. The reservation service company who coordinates the server and operation will have to manually find a company to accept the transportation service reservation at step 122. Then, the server sends customer information to the TSP who accepts the transportation service reservation and sends the TSP information to the customer at 119. The number of brackets for a specified transportation service may vary.

The First TSP to accept the business wins said business. End-user will pay pre-determined starting price and TSPs will accept their own estimated flat fee saved in the database. The system will keep as profit the difference between the two.

Although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A business method of providing transportation service reservation system via internet, the method comprising establishing the transportation service providers and service fees database which comprises:
asking the transportation service providers (TSP) who are interested in utilizing the transportation service reservation system to fill out a sign-up form, wherein TSP giving estimated flat fees for a list of specified transportation service including general pick-up/drop-off at certain locations including but not limited to airport, train station, and cruise ports, as well as a flat rate per mile for an unspecified transportation service;
saving the TSP's information and estimated flat fees for specified trip services and flat rate per mile for unspecified services in a database;
Grouping TSP for each specified transportation service according to the estimated flat rate for each specified transportation service into several baskets in a step ladder approach and saving the basket in database; and
Calculating and determines a price quote for each specified service and saving the price quote in the database for said transportation service.

2. The business method of claim 1, wherein the baskets grouped by the step ladder approach in the database includes a first basket consists of the service providers whose estimated flat fee is one of the lowest for said trip; a second basket consists of the service providers whose estimated flat fee is higher than the first bracket but lower than the third bracket for said trip; a third basket consists of the service providers whose estimated flat fee is higher than the second bracket but lower than the fourth bracket for said trip; the fourth bracket consists of the service providers whose estimated flat fee are higher than the third bracket but lower than the fifth bracket; the fifth bracket consists of the service providers whose estimated flat fee are higher than the fourth bracket.

3. The business method of claim 1, wherein the database is updated frequently so that the TSP can update the estimated flat fee for specified services and estimated flat rate for unspecified services as well as vehicles availability.

4. The business method of claim 3, further comprising:
receiving digital transportation service request from a customer;
validating transportation service request from the customer;
accessing the database to search for a price quote corresponding to the transportation service requested by the customer;
sending the price quote to the customer;
receiving reservation confirmation from the customer;
sending notice to the TSPs who are grouped in the first basket,
receiving confirmation from the TSP of the first basket,
digitally transmitting customer's reservation information to the TSP who first responds to the notice to accept the reservation; and
digitally transmitting TSP information to the customer.

5. The business method of claim 4, further comprising:
calculating a price quote if a price quote corresponding to the transportation service does not exist in the database.

6. The business method of claim 5, wherein if no TSP from the first bracket responds to the notice, the server sending another round of notice to the TSPs who are grouped in a basket one level above until no more higher baskets exists and if no TSP responds to the notice, sending alert to trigger a manual search of TSP to accept the transportation service reservation.

7. The business method of claim 6, the business method enables the customer to reserve transportation services reservation on the same website of airline, train, cruise ship, wherein the system is incorporated with graphical user interface of the website of airline, train, cruise ship.

8. The business method of claim 5, further comprising accepting payment from the customer.

9. The business method of claim 8, further comprising receiving customer feedback regarding the travel with TSP and updating its feedback data.

10. The business method of claim 9, further comprising digitally transmitting identification information of the customer to the transportation service reservation server for verification.

11. The business method of claim 10, wherein the specified transportation service including pick-up/drop-off from and to certain locations including but not limited to popular locations including airport, train station, bus station, cruise port, hotels, popular sightseeing spots.

12. The business method of claim 11, wherein the transportation service request includes at least one of: location information regarding desired transportation, time of desired transportation, or payment method.

13. The business method of claim 12, further comprising an app on smart phones and a website for customers to access the transportation service reservation system.
